(19) United States
(12) Patent Application Publication
(10) Pub. No.: US 2015/0269129 A1
(43) Pub. Date: Sep. 24, 2015

(54) METHOD FOR ADDING BOOKMARKS AND BROWSER

(71) Applicant: TENCENT TECHNOLOGY (SHENZHEN) COMPANY LIMITED, Shenzhen (CN)

(72) Inventor: Ningjun Dou, Shenzhen (CN)

(21) Appl. No.: 14/733,997

(22) Filed: Jun. 9, 2015

Related U.S. Application Data
(63) Continuation of application No. PCT/CN2013/089336, filed on Dec. 13, 2013.

(30) Foreign Application Priority Data
Dec. 21, 2012 (CN) 201210562554.1

(51) Int. Cl. G06F 17/22; G06F 3/0484; G06F 17/30

(52) U.S. Cl. CPC G06F 17/2235; G06F 17/30876; G06F 3/0484

(57) ABSTRACT

A method for adding bookmarks and a browser are described. When accessing a webpage, current frequency information of accessing the webpage by a browser is counted. If the frequency information meets a preset condition, a selection interface is displayed. The selection interface is configured for a user to select whether to add the webpage as a bookmark. The webpage is added as a bookmark according to a confirmation instruction after obtaining the confirmation instruction of adding the webpage as a bookmark. The browser includes a counting unit, a displaying unit and an adding unit. The counting unit is configured to count current frequency information of accessing the webpage. The displaying unit is configured to, if the frequency information counted by the counting unit meets a preset condition, display a selection interface. The adding unit is configured to add the webpage as a bookmark according to a confirmation instruction.

### CROSS-REFERENCES TO RELATED APPLICATIONS

This application is a continuation of International Application No. PCT/CN2013/089336, filed on Dec. 13, 2013, which claims priority to Chinese patent application No. 201210562554.1, filed on Dec. 21, 2012, the content of which are incorporated herein by reference in their entirety.

### FIELD OF THE DISCLOSURE

The present disclosure relates to internet technology, and more particularly to a method for adding bookmarks and browser.

### BACKGROUND

With the rapid development of the internet technology, browsers have been widely used in the internet. A browser can obtain webpage content corresponding to a website according to the website input by a user, and display the webpage content on a display interface of the browser. In actual applications, for a complex website, it can be added to a favorite as a bookmark, or it can be added to quick links in the browser, so as to realize fast access to the website. One process of adding a target website to a favorite as a bookmark includes: when a browser displays a webpage, displaying a dialog box of adding the currently displayed webpage as a bookmark if an add favorite option is activated; after determining a webpage name and a local storage path, adding a bookmark of the currently displayed webpage to a favorite of the browser. After the bookmark of the webpage is added to the browser, the browser can quickly obtain the website of the webpage through the bookmark, thereby realizing fast access to the website. However, in the above process, the browser requires multiple interactions with the user and the browser needs to perform multi-step operations, resulting in a complicated process of adding a bookmark.

### SUMMARY

One embodiment of the present disclosure provides a method for adding bookmarks and browser, which can make the process of adding a bookmark quicker and easier.

A method for adding bookmarks includes:

when accessing a webpage, counting current frequency information of accessing the webpage by a browser;

displaying a selection interface if the frequency information meets a preset condition; wherein the selection interface is configured for a user to select whether to add the webpage as a bookmark;

obtaining a confirmation instruction of adding the webpage as a bookmark and adding the webpage as a bookmark according to the confirmation instruction.

A browser includes a counting unit, a displaying unit and an adding unit; wherein

the counting unit is configured to, when accessing a webpage, count current frequency information of accessing the webpage by a browser

the displaying unit is configured to, if the frequency information counted by the counting unit meets a preset condition, display a selection interface which is configured for a user to select whether to add the webpage as a bookmark;

the adding unit is configured to obtain a confirmation instruction of adding the webpage as a bookmark, and add the webpage as a bookmark according to the confirmation instruction.

A browser device comprising a processor and a memory; wherein the processor and the memory are connected with each other via an internal bus; the memory stores a set of instructions for performing a method for adding bookmarks, the set of instructions to direct the processor to perform acts of:

when accessing a webpage, counting current frequency information of accessing the webpage by a browser;

detecting whether the frequency information meets a preset condition;

if the frequency information meets a preset condition, automatically displaying a selection interface which is configured for a user to select whether to add the webpage as a bookmark;

directly adding the webpage as a bookmark in a default storage path if obtaining a confirmation instruction of adding the webpage as a bookmark through the selection interface.

In the method for adding bookmark and the browser according to embodiments of the present disclosure, when accessing a webpage, current frequency information of accessing the webpage by a browser is counted, and a selection interface is displayed if the frequency information meets a preset condition; obtaining a confirmation instruction of adding the webpage as a bookmark through the selection interface which is configured for a user to select whether to add the webpage as a bookmark, and the webpage is added as a bookmark according to the confirmation instruction. In one embodiment of the present disclosure, the browser requires only one interaction with the user and thus the browser needs to perform fewer operations. While the browser in the related art needs to add the bookmark of the currently displayed webpage to the favorite of the browser after the add favorite option is activated as well as the webpage name and the local storage path are determined, thus the browser in the related art requires multiple interactions with the user and performs more operations. Therefore, the method for adding bookmark according to one embodiment of the present disclosure can make the process of adding a bookmark quicker and easier.

### BRIEF DESCRIPTION OF DRAWINGS

FIG. 1 a flowchart of a method for adding bookmarks according to one embodiment of the present disclosure;

FIG. 2 a flowchart of a method for adding bookmarks according to another embodiment of the present disclosure;

FIG. 3 is a schematic diagram of a browser according to one embodiment of the present disclosure;

FIG. 4 is a schematic diagram of a browser according to another embodiment of the present disclosure;

FIG. 5 is a schematic diagram of a browser device according to one example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

As shown in FIG. 1, a method for adding bookmarks according to one embodiment of the present disclosure includes:

101: when accessing a webpage, counting current frequency information of accessing the webpage by a browser;

Specifically, the frequency information can include a frequency value of accessing the webpage. The frequency value relates to a number of times of accessing the webpage and a time interval of accessing the webpage. For example, if a number of times of accessing the webpage is 5 times and the time interval is 2 days, then the frequency value can be represented as 2.5 times per day.

102: if the frequency information meets a preset condition, displaying a selection interface.

The selection interface is configured for a user to select whether to add the webpage as a bookmark.

Specifically, the selection interface at least includes a confirmation option and a negation option. The confirmation option is configured to, after the confirmation option is activated, confirm adding the webpage as a bookmark. The negation option is configured to, after the negation option is activated, not add the webpage as a bookmark.

103: obtaining a confirmation instruction of adding the webpage as a bookmark, and adding the webpage as a bookmark according to the confirmation instruction.

Specifically, the confirmation instruction can be, for example, that the confirmation option in the selection interface is activated.

Specifically, after adding the webpage as a bookmark, the bookmark can be added to a favorite in the browser, or can be added to quick links in the browser.

In the method for adding bookmark according to one embodiment of the present disclosure, when accessing a webpage, current frequency information of accessing the webpage by a browser is counted, and a selection interface is displayed if the frequency information meets a preset condition; obtaining a confirmation instruction of adding the webpage as a bookmark through the selection interface which is configured for a user to select whether to add the webpage as a bookmark, and the webpage is added as a bookmark according to the confirmation instruction. In one embodiment of the present disclosure, the browser requires only one interaction with the user and thus the browser needs to perform fewer operations. While the browser in the related art needs to add the bookmark of the currently displayed webpage to the favorite of the browser after the add favorite option is activated as well as the webpage name and the local storage path are determined, thus the browser in the related art requires multiple interactions with the user and performs more operations. Therefore, the method for adding bookmark according to one embodiment of the present disclosure can make the process of adding a bookmark quicker and easier.

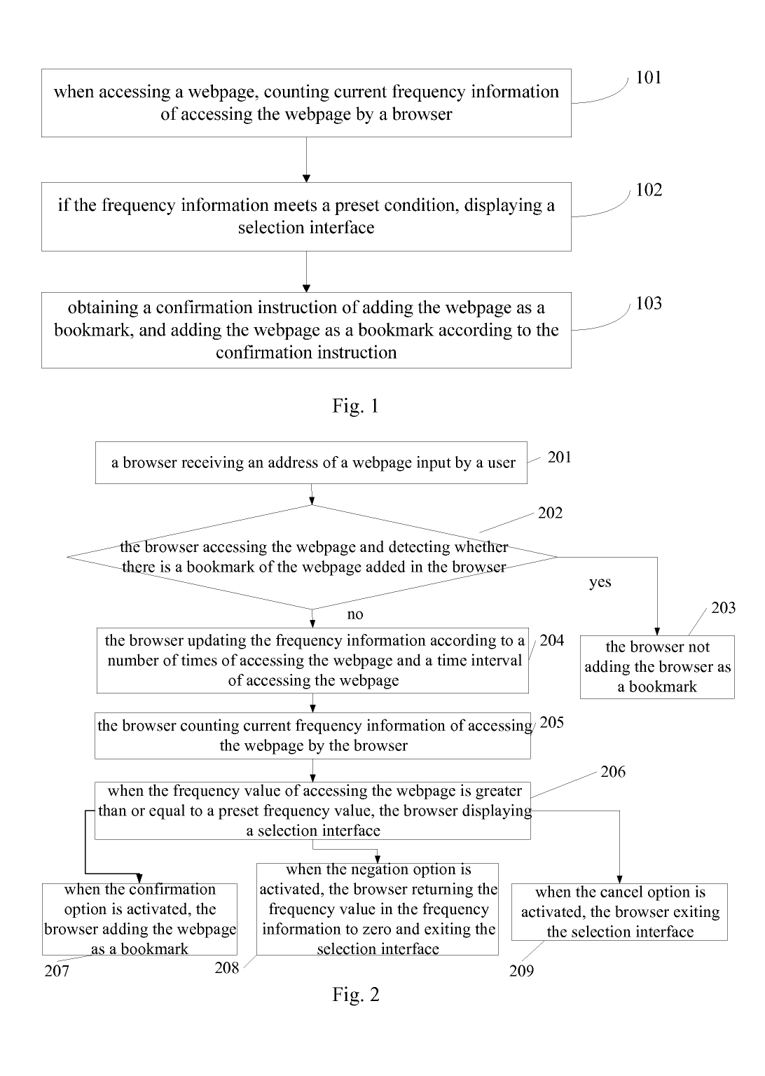

As shown in FIG. 2, a method for adding bookmark according to another embodiment of the present disclosure includes:

201: a browser receiving an address of a webpage input by a user;

202: the browser accessing the webpage and detecting whether there is a bookmark of the webpage added in the browser. If detecting that there is a bookmark of the webpage added in the browser, performing step 203; otherwise, if detecting that there is not a bookmark of the webpage added in the browser, performing step 204;

203: the browser not adding the browser as a bookmark.

204: the browser updating the frequency information according to a number of times of accessing the webpage and a time interval of accessing the webpage.

Specifically, the frequency information can include a frequency value of accessing the webpage. When detecting that there is not a bookmark of the webpage added in the browser, the number of times of accessing the webpage is plus one due to current access to the webpage. For example, if a previous number of times of accessing the webpage is 5 and a previous time interval is 2 days, then previous frequency information can be represented as 2.5 times per day; if a user continues to access the webpage within the 2 days of the time interval, then the current number of times of accessing the webpage is 6 and the frequency value in the frequency information can be updated as 3 times per day.

205: the browser counting current frequency information of accessing the webpage by the browser.

Specifically, the frequency value of the frequency information relates to a number of times of accessing the webpage and a time interval of accessing the webpage. For example, if a number of times of accessing the webpage is 5 times and the time interval is 2 days, then the frequency value can be represented as 2.5 times per day.

206: when the frequency value of accessing the webpage is greater than or equal to a preset frequency value, the browser displaying a selection interface.

The selection interface is configured for a user to select whether to add the webpage as a bookmark. The selection interface includes a confirmation option, a negation option and a cancel option. When the three options are activated respectively, performing step 207, step 208 or step 209, respectively.

207: when the confirmation option is activated, the browser adding the webpage as a bookmark.

Specifically, after adding the webpage as a bookmark, the bookmark can be added to a favorite in the browser, or can be added to quick links in the browser.

208: when the negation option is activated, the browser returning the frequency value in the frequency information to zero and exiting the selection interface.

Specifically, when the negation option is activated, it means not adding the browser as a bookmark. Thus, the number of times of accessing the webpage recorded in the browser can be returned to zero and can be recounted in next accessing; and the selection interface will be displayed when the frequency value in the frequency information is greater than or equal to the preset frequency value again.

209: when the cancel option is activated, the browser exiting the selection interface.

Specifically, the selection interface can be a weak prompt interface, i.e., if the weak prompt interface is not operated for some time, the weak prompt interface will exit. If it is required to immediately exit the selection interface, the cancel option can be activated. In case of exiting the selection interface because the weak prompt interface is not operated for some time or the cancel option is activated, the frequency value in the frequency information will be retained. When accessing the webpage for the next time, the browser will continues to display the selection interface.

In the method for adding bookmark according to another embodiment of the present disclosure, when accessing a webpage, current frequency information of accessing the webpage by a browser is counted, and a selection interface is displayed if the frequency information meets a preset condition; obtaining a confirmation instruction of adding the webpage as a bookmark through the selection interface which is configured for a user to select whether to add the webpage as a bookmark, and the webpage is added as a bookmark according to the confirmation instruction. In one embodiment of the present disclosure, the browser requires only one interaction with the user and thus the browser needs to perform fewer operations. While the browser in the related art needs to add the bookmark of the currently displayed webpage to the favorite of the browser after the add favorite option is activated as well as the webpage name and the local storage path are determined, thus the browser in the related art requires multiple interactions with the user and performs more operations. Therefore, the method for adding bookmark according to one embodiment of the present disclosure can make the process of adding a bookmark quicker and easier.

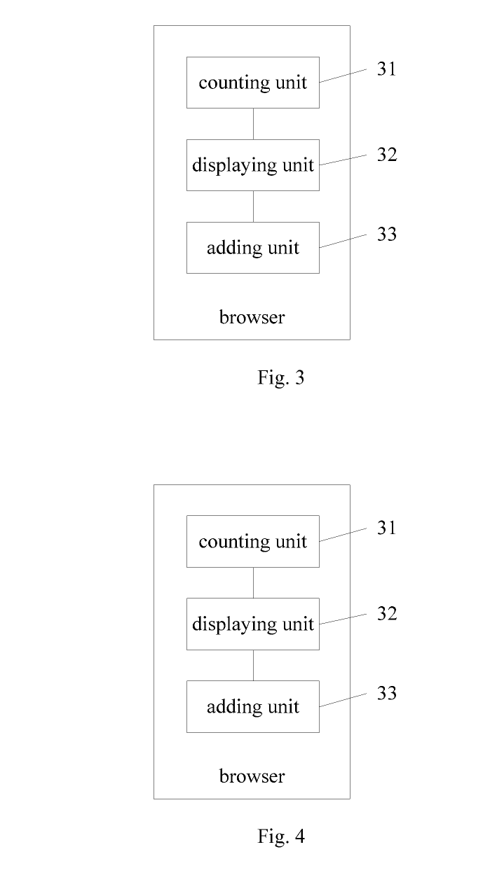

FIG. 3 is a schematic diagram of a browser according to one embodiment of the present disclosure. Here, the browser refers to a device including a program that accesses and displays files and other data available on the Internet and other network, and can also be called browser device. As shown in FIG. 3, the browser includes a counting unit 31, a displaying unit 32 and an adding unit 33.

The counting unit 31 is configured to, when accessing a webpage, count current frequency information of accessing the webpage by a browser. The specific implementation can refer to the step 101 in FIG. 1, and will not be repeated here.

The displaying unit 32 is configured to, if the frequency information counted by the counting unit 31 meets a preset condition, display a selection interface which is configured for a user to select whether to add the webpage as a bookmark. The specific implementation can refer to the step 102 in FIG. 1, and will not be repeated here.

The adding unit 33 is configured to obtain a confirmation instruction of adding the webpage as a bookmark, and add the webpage as a bookmark according to the confirmation instruction. The specific implementation can refer to the step 103 in FIG. 1, and will not be repeated here.

Specifically, as shown in FIG. 4, the frequency information can include a frequency value of accessing the webpage. The preset condition includes a preset frequency value.

The displaying unit 32 is specifically configured to, when the frequency value of accessing the webpage is greater than or equal to the preset frequency value, display the selection interface. The specific implementation can refer to the step 206 in FIG. 2, and will not be repeated here.

Further, as shown in FIG. 4, the browser further includes a detection unit 34 and an updating unit 35.

The detection unit 34 is configured to, when accessing the webpage, detect whether there is a bookmark of the webpage added in the browser. The specific implementation can refer to the step 202 in FIG. 2, and will not be repeated here.

The updating unit 35 is configured to, if the detection unit 34 detects that there is not a bookmark of the webpage added in the browser, update the frequency information. The specific implementation can refer to the step 204 in FIG. 2, and will not be repeated here.

Specifically, as shown in FIG. 4, the updating unit 35 is specifically configured to:

update the frequency information according to a number of times of accessing the webpage and a time interval of accessing the webpage. The specific implementation can refer to the step 204 in FIG. 2, and will not be repeated here.

Specifically, as shown in FIG. 4, the selection interface includes a confirmation option, a negation option and a cancel option.

The adding unit 33 is specifically configured to,

when the confirmation option is activated, add the webpage as a bookmark. The specific implementation can refer to the step 207 in FIG. 2, and will not be repeated here.

Further, as shown in FIG. 4, the browser further includes:

an exit unit 36 configured to, when the negation option is activated, return the frequency value in the frequency information to zero and exit the selection interface. The specific implementation can refer to the step 208 in FIG. 2, and will not be repeated here.

The exit unit 36 is further configured to, when the cancel option is activated, exit the selection interface. The specific implementation can refer to the step 209 in FIG. 2, and will not be repeated here.

In the browser according to one embodiment of the present disclosure, when accessing a webpage, current frequency information of accessing the webpage by a browser is counted, and a selection interface is displayed if the frequency information meets a preset condition; obtaining a confirmation instruction of adding the webpage as a bookmark through the selection interface which is configured for a user to select whether to add the webpage as a bookmark, and the webpage is added as a bookmark according to the confirmation instruction. In one embodiment of the present disclosure, the browser requires only one interaction with the user and thus the browser needs to perform fewer operations. While the browser in the related art needs to add the bookmark of the currently displayed webpage to the favorite of the browser after the add favorite option is activated as well as the webpage name and the local storage path are determined, thus the browser in the related art requires multiple interactions with the user and performs more operations. Therefore, the method for adding bookmark according to one embodiment of the present disclosure can make the process of adding a bookmark quicker and easier.

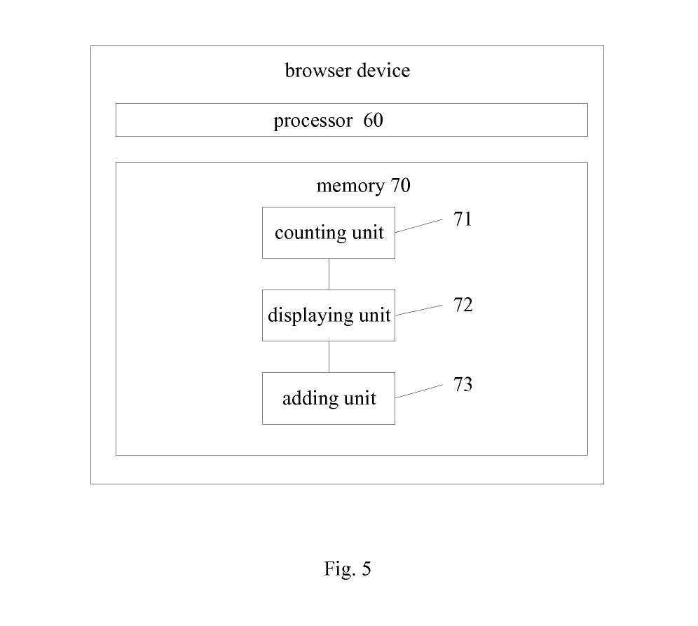

FIG. 5 shows a browser device according to one example of the present disclosure. As shown in FIG. 5, the browser device (such as a mobile phone, a tablet computer, a desktop computer, and so on) includes a processor 60 and a memory 70. The processor 60 and the memory 70 are connected with each other via an internal bus. The memory 70 may be a non-transitory computer-readable storage medium, and stores units of machine readable instructions executable by the processor 60, including a counting unit 71, a displaying unit 72 and an adding unit 73. Functions of the counting unit 71, the displaying unit 72 and the adding unit 73 are similar with the functions of the counting unit 31, the displaying unit 32 and the adding unit 33. The functions may be implemented with the assistance of other modules, and may involve cooperation of multiple modules, e.g., may utilize processing functions of the processor 60, may relay on the internal bus for data transmission, and etc.

The methods, units, modules, and browser described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided to store instructions to cause a machine to execute a process as described according to examples herein. Specifically, a system or apparatus having a storage medium that stores machine-readable program codes for implementing functions of any of the above examples and that may cause the system or the apparatus (or processor such as CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. The program code may be downloaded from a server computer via a communication network.

It should be noted that, alternatively to the program codes being executed by a computer, at least part of the operations performed by the program codes may be implemented by an operation system running in a computer following instructions based on the program codes to implement any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to implement any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for adding bookmarks comprising:
when accessing a webpage, counting current frequency information of accessing the webpage by a browser;
displaying a selection interface if the frequency information meets a preset condition; wherein the selection interface is configured for a user to select whether to add the webpage as a bookmark;
obtaining a confirmation instruction of adding the webpage as a bookmark and adding the webpage as a bookmark according to the confirmation instruction.

2. The method of claim 1, wherein the frequency information comprises a frequency value of accessing the webpage; the preset condition comprises a preset frequency value;
the displaying a selection interface if the frequency information meets a preset condition comprises:
when the frequency value of accessing the webpage is greater than or equal to a preset frequency value, displaying the selection interface.

3. The method of claim 2, wherein before the counting current frequency information of accessing the webpage by a browser, the method further comprises:
when accessing the webpage, detecting whether there is a bookmark of the webpage added in the browser;
if detecting that there is a bookmark of the webpage added in the browser, updating the frequency information.

4. The method of claim 3, wherein the updating the frequency information comprises:
updating the frequency information according to a number of times of accessing the webpage and a time interval of accessing the webpage.

5. The method of claim 3, wherein the selection interface comprises a confirmation option, a negation option and a cancel option;
the obtaining a confirmation instruction of adding the webpage as a bookmark and adding the webpage as a bookmark according to the confirmation instruction comprises:
when the confirmation option is activated, adding the webpage as a bookmark.

6. The method of claim 5, wherein after the displaying a selection interface, the method further comprises:
when the negation option is activated, returning the frequency value in the frequency information to zero and exiting the selection interface;
when the cancel option is activated, exiting the selection interface.

7. A browser comprising a counting unit, a displaying unit and an adding unit; wherein
the counting unit is configured to, when accessing a webpage, count current frequency information of accessing the webpage by a browser
the displaying unit is configured to, if the frequency information counted by the counting unit meets a preset condition, display a selection interface which is configured for a user to select whether to add the webpage as a bookmark;
the adding unit is configured to obtain a confirmation instruction of adding the webpage as a bookmark, and add the webpage as a bookmark according to the confirmation instruction.

8. The browser of claim 7, wherein the frequency information comprises a frequency value of accessing the webpage; the preset condition comprises a preset frequency value;
the displaying unit is specifically configured to,
when the frequency value of accessing the webpage is greater than or equal to the preset frequency value, displaying the selection interface.

9. The browser of claim 8, further comprising:
a detection unit configured to, when accessing the webpage, detect whether there is a bookmark of the webpage added in the browser;
an updating unit configured to, if the detection unit detects that there is not a bookmark of the webpage added in the browser, update the frequency information.

10. The browser of claim 9, wherein the updating unit is specifically configured to,
update the frequency information according to a number of times of accessing the webpage and a time interval of accessing the webpage.

11. The browser of claim 9, wherein the selection interface includes a confirmation option, a negation option and a cancel option;
the adding unit is specifically configured to,
when the confirmation option is activated, add the webpage as a bookmark.

12. The browser of claim 11, further comprising:
an exit unit configured to, when the negation option is activated, return the frequency value in the frequency information to zero and exit the selection interface;
wherein the exit unit is further configured to, when the cancel option is activated, exit the selection interface.

13. A browser device comprising a processor and a memory; wherein the processor and the memory are connected with each other via an internal bus; the memory stores a set of instructions for performing a method for adding bookmarks, the set of instructions to direct the processor to perform acts of:
when accessing a webpage, counting current frequency information of accessing the webpage by a browser;
detecting whether the frequency information meets a preset condition;
if the frequency information meets a preset condition, automatically displaying a selection interface which is configured for a user to select whether to add the webpage as a bookmark;
directly adding the webpage as a bookmark in a default storage path if obtaining a confirmation instruction of adding the webpage as a bookmark through the selection interface.

14. The browser device of claim 13, wherein the frequency information comprises a frequency value of accessing the webpage; the preset condition comprises a preset frequency value;
when the frequency value of accessing the webpage is greater than or equal to the preset frequency value, the frequency information meets the preset condition.

15. The browser device of claim 14, wherein the selection interface comprises a confirmation option, a negation option and a cancel option; the confirmation option is configured to, after the confirmation option is activated, confirm adding the webpage as a bookmark by the confirmation instruction of adding the webpage as a bookmark.
